(19) United States
(12) Patent Application Publication
(10) Pub. No.: US 2014/0367600 A1
(43) Pub. Date: Dec. 18, 2014

(54) VALVE, IN PARTICULAR FOR A MOTOR VEHICLE ENGINE

(71) Applicant: Valeo Sytemes de Controle Moteur, Cergy Saint Christophe (FR)

(72) Inventor: Grégory Hodebourg, Sartrouville (FR)

(73) Assignee: VALEO SYSTEMES DE CONTROLE MOTEUR, Cergy Saint Christophe (FR)

(21) Appl. No.: 14/353,091

(22) PCT Filed: Oct. 11, 2012
(86) PCT No.: PCT/FR2012/052309

§ 371 Date: Apr. 21, 2014

(30) Foreign Application Priority Data
Oct. 26, 2011 (FR) 1159712

(51) Int. Cl. F02M 25/07

(52) U.S. Cl. CPC F02M 25/0793
USPC 251/308

(57) ABSTRACT

The invention relates to re-circulated exhaust gas valve for a motor vehicle engine, including a flap (2) and a shaft (7) for driving the flap (2) about an axis of rotation, said flap (2) and said shaft (7) being inserted one inside the other in the area of one or more connecting barrels (5) forming a thermal conduction area between the flap (2) and the shaft (7), the valve being characterized in that said valve includes a cavity (28) configured such as to localize the thermal conduction area axially and set back from a first edge of the flap (2) turned toward an axial end of the shaft (7), which is connected to members for driving the valve.

The invention relates to a valve for a motor vehicle engine, and more particularly to a valve for recirculated exhaust gases.

It is well known nowadays to recycle the exhaust gases of an engine by connecting the inlet circuit and the exhaust pipe of the combustion engine. Such a recycling device makes it possible to reuse a portion of the exhaust gases in the mix supplied to the combustion engine.

Anti-pollution standards now make it necessary to recycle a larger portion of the exhaust gases. However, further improvement with respect to the quantity of exhaust gas which can be recycled is difficult with the current architecture. In order to improve the recycling of exhaust gases, one considered option is to connect a recycling device to the low-pressure portion of the exhaust pipe, that is to say downstream of the exhaust gas expansion region, in order to direct a more substantial part of the exhaust gases toward the inlet circuit of the combustion engine.

It is thus known to have a valve mounted on the low-pressure portion of the exhaust pipe, by means of which it is possible to direct the exhaust gases either outward or toward the recycling device and which comprises a flap, a drive shaft for driving the flap and an actuating motor and transmission means configured so as to transmit the movement of the motor to the shaft.

Mounting the shaft on the body of the valve is performed with clearances, allowing it to rotate. Such clearances allow a quantity of exhaust gas to filter through the valve towards the transmission and actuating members used. As these gases might damage the driving members, in particular by condensing, a seal is inserted along the shaft in order to block these gases.

However, in the valve, the flap and the shaft are push-fitted one into the other at one or more connecting barrels, which establishes a region of thermal conduction between the flap and the shaft. The flap is exposed directly to the exhaust gases and conducts the heat to the shaft via the barrel or barrels.

It is nowadays known to cool the valve, which makes it possible to have a shaft whose temperature, in line with the seal, is lower than at the flap. However, this cooling remains limited and the seal must withstand the heat. It is therefore costly and makes assembling the valve more complex.

Furthermore, in this portion of the pipe, the exhaust gases can undergo pollution-removing treatments, in particular post-combustion, which can further raise their temperature. The valve must be designed to withstand this temperature, thus increasing the cost of the valve and more particularly that of the seal.

One solution would be to move the transmission and actuation members as far as possible away from the ducts in which the hot exhaust gases circulate. However, it is on the contrary desirable for the valve to have a structure which is compact and neatly arranged on the exhaust pipe in order to limit the bulkiness thereof. In such a structure, the length of the drive shaft of the flap is necessarily limited, which makes it difficult to cool the valve along the shaft.

It is an object of the invention to resolve these drawbacks at least in part. To that end, the invention relates to a gas valve, in particular for recirculated exhaust gases for a motor vehicle engine, comprising a flap and a shaft for driving the flap about an axis of rotation, said flap and said shaft being push-fitted one into the other at one or more connecting barrels establishing a region of thermal conduction between the flap and the shaft, wherein the valve comprises at least one cavity, in particular one cavity, configured so as to locate the region of thermal conduction axially set back from a first edge of the flap facing toward one axial end of the shaft, which end is connected to members for driving the valve.

The temperature reached in line with the seal can be reduced, by virtue of the cavity thus created, by moving the median temperature point toward the flap. It is thus possible in particular to use a classical seal, for example made of rubber, which is not costly, without having to extend the shaft.

The cavity is preferably located between the shaft and the flap, in particular radially.

Again preferably, the annular space extends axially from a passage by means of which the shaft enters a body of the valve.

According to one aspect of the invention, the cavity is delimited by an annular space created in a sidewall of the shaft.

The diameter of the shaft is advantageously smaller in its portion located at the annular space.

The diameter of the shaft is also advantageously identical on either side of said annular space.

In one embodiment of the invention, the flap has a radial offset with respect to the axis of rotation.

It can then be configured so as to act as a heat shield for the shaft with respect to the flow of gas in the valve.

In this embodiment, as a variant, the connecting barrel or that one of the connecting barrels which is close to the first edge is axially set back from said first edge. In other words, there is a portion of the flap comprising the first edge thereof which is positioned directly opposite the shaft, without the intermediary of the barrel. The space freed up by the axial setback of this barrel can then form the cavity.

According to this embodiment, one or more other additional cavities can be provided, for example one additional cavity created in the sidewall of the shaft and/or in the wall of the barrel. Along the shaft there can thus be created: the cavity formed by the axial setback of the barrel close to the first edge of the flap, and one or more other cavities created in the shaft and/or in the barrel.

Advantageously, said valve further comprises a second connecting barrel at a distance from the barrel provided close to the first edge. In this case, the additional cavity or cavities can be created at this second barrel.

In an alternative embodiment of the invention, the flap is aligned on the axis of rotation. In such a valve, the barrel is directly exposed to the exhaust gases and conducts the heat received to the drive shaft.

The flap advantageously comprises two wings which are secured to the barrel or barrels and are mounted symmetrically on either side of the barrel or barrels with respect to said axis of rotation. It is understood here that the axis of rotation is substantially in the median plane defined by the wings.

Still more preferably, the thickness of the flap is less than the diameter of the connecting barrel or barrels.

In this embodiment, the cavity is created between the barrel and the shaft so as to dissipate the heat and thus to reduce the conduction of heat along the shaft.

In a first variant, the cavity is delimited by an annular space created in a sidewall of the shaft, as in one of the variants relating to the flap having a radial offset.

In another variant, the cavity is delimited by an annular space created in the barrel or that one of the barrels which is close to the first edge.

The drive shaft is then preferably of constant cross section as can be the case for valves provided with a radially offset flap and a connecting barrel axially set back from the first edge.

In one variant, the cavity is created both in the barrel and in the shaft.

The shaft is preferably substantially cylindrical. The shaft may be of circular, rectangular, square or any other cross section, in one piece or in the form of an assembly of parts such as a plurality of shafts assembled with one another, or rods, etc.

Advantageously, the connecting barrel or barrels are formed directly from the material of the flap.

Other features and advantages of the invention will become apparent from the following description given in relation to the appended figures which are given as non-limiting examples, wherein similar objects are given identical references. In the figures:

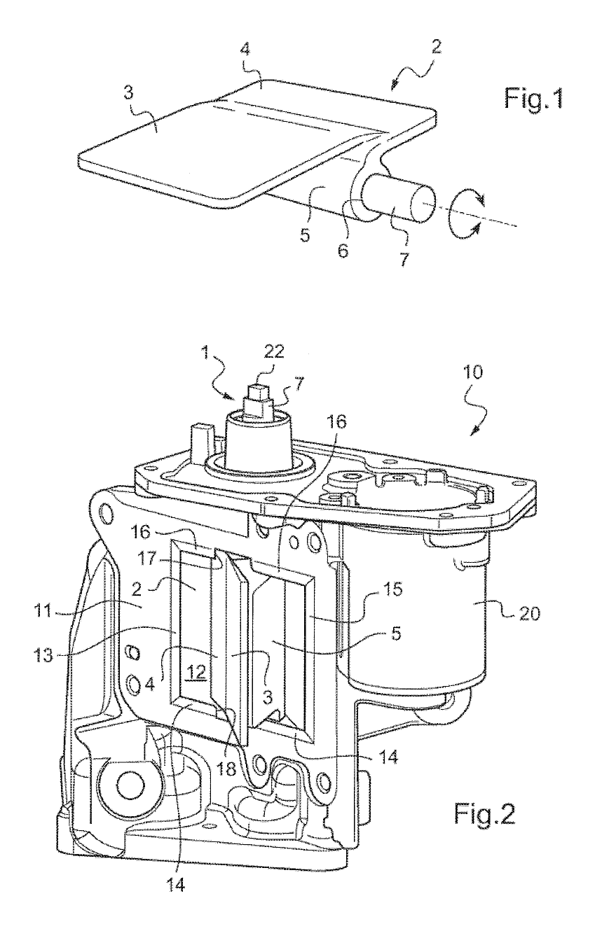

FIG. 1 shows in perspective a flap which is off-center with respect to its axis of rotation.

FIG. 2 shows in perspective, in part, a valve provided with the flap of FIG. 1, in the open position.

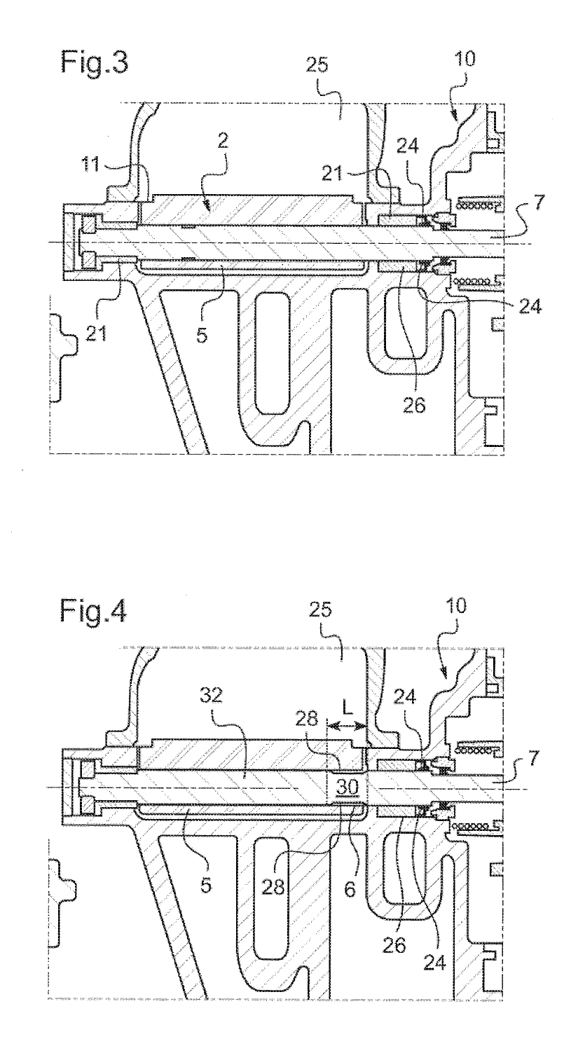

FIG. 3 is a view in longitudinal section, at the drive shaft of the valve of FIG. 2, in the closed position.

FIG. 4 is a view similar to that of FIG. 3 according to a first embodiment of the invention.

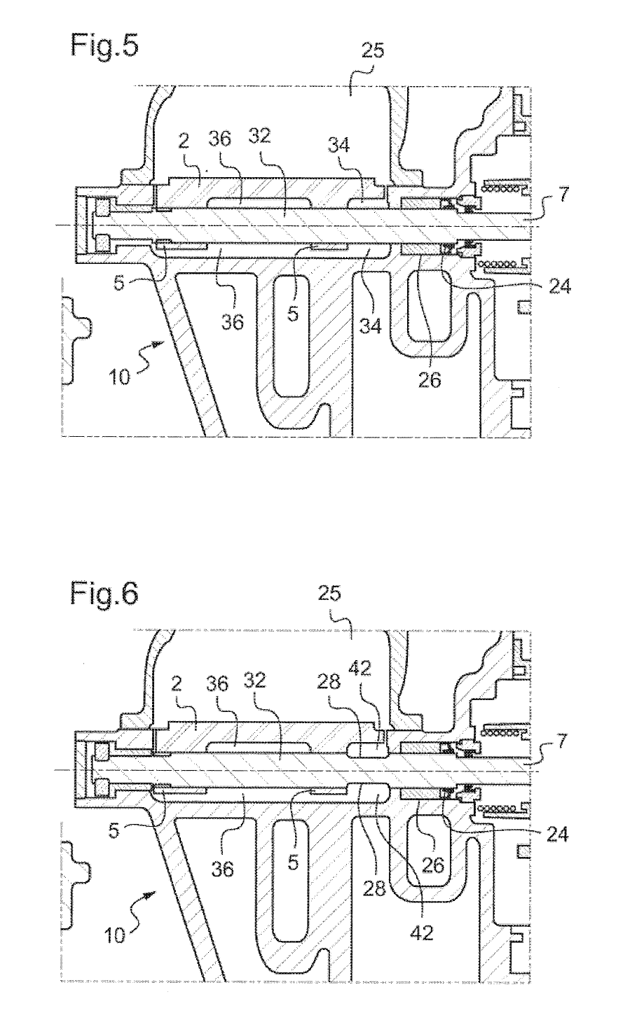

FIG. 5 is a view similar to that of FIG. 3 according to a second embodiment of the invention.

FIG. 6 is a view similar to that of FIG. 3 according to a third embodiment of the invention.

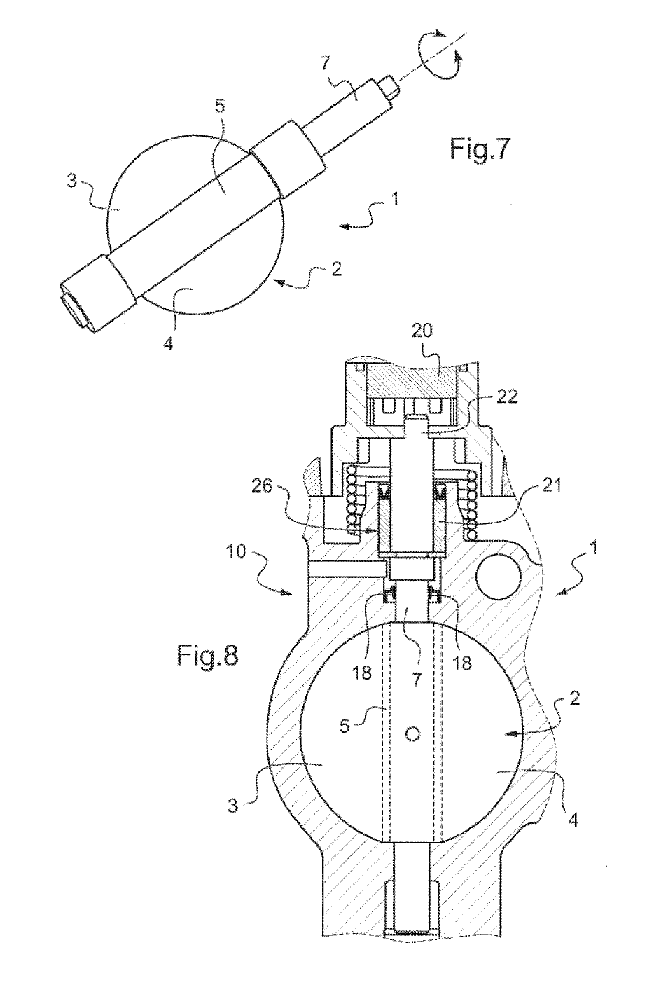

FIG. 7 shows, in perspective, a schematic view of part of a flap comprising a barrel and two wings mounted symmetrically on the barrel and diametrically secured to a drive shaft.

FIG. 8 shows a cross section view of a valve comprising a flap according to FIG. 7, in the closed position.

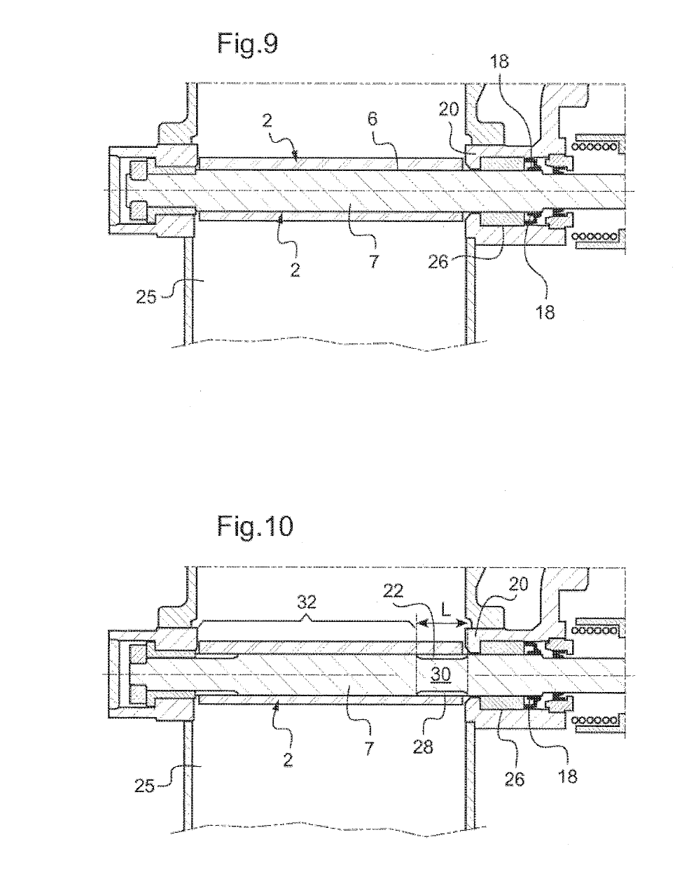

FIG. 9 is a view in longitudinal section of the valve of FIG. 8, in the closed position.

FIG. 10 is a view similar to that of FIG. 9 according to a fourth embodiment of the invention.

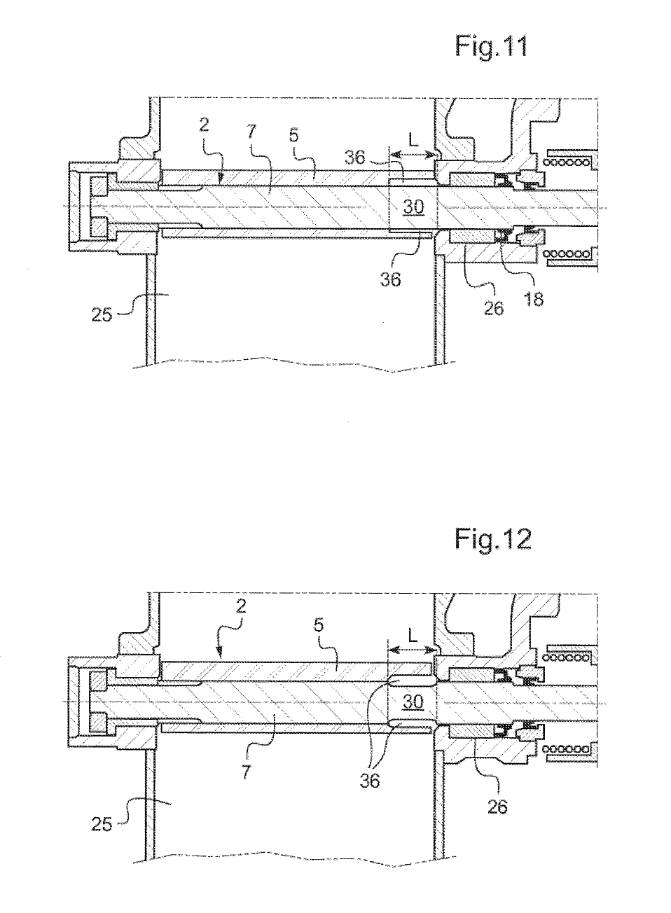

FIG. 11 is a view similar to that of FIG. 9 according to a fifth embodiment of the invention.

FIG. 12 is a view similar to that of FIG. 9 according to a sixth embodiment of the invention.

FIG. 1 shows a flap 2 of a gas valve, in particular for recirculated exhaust gases for a motor vehicle engine. The valve 2 and a drive shaft 7 of said flap are push-fitted one into the other at a connecting barrel 5. The flap 2 is oriented substantially parallel to its axis of rotation which corresponds to the longitudinal axis of the shaft 7.

In the embodiment of FIG. 1, the flap 2 is radially offset with respect to its axis of rotation.

Such a flap comprises, in particular, a first wing 3 secured to a second wing 4 which in turn is secured to the barrel 5. The wings 3 and 4 and the barrel 5 can, for example, be formed directly from the same material. The wings 3 and 4 are substantially rectangular. The barrel 5 is substantially cylindrical and comprises a bore 6, which is also substantially cylindrical, created coaxially in the barrel 5. It is to be noted that the wings 3 and 4 may, in an alternative embodiment of the invention, be in one and the same plane, that is to say they may form a single wing positioned on either side of the barrel.

FIG. 2 shows a valve 1 which takes the form of a casing 10 in which the flap 2 is mounted. This is a valve by means of which exhaust gases can be selectively directed either outward or toward a recycling circuit.

The drive shaft 7 comprises an end 22 connected to an actuating motor 20 via transmission means (not shown) configured so as to transmit the movement of the motor to the flap 2 via the shaft 7.

The casing 10 comprises a flange 11 in which there is created an opening 12 delimited by miters 13, 14, 15, 16 which project into the opening 12 and on which the valve 1 is mounted in order to allow the flap 2 to pivot between a plurality of open positions, and one closed position, of the opening 12.

The miters 13, 14, 15, 16 are configured so as to seal the valve 1 when the flap 2 is in the closed position.

As shown in FIG. 3, the casing 10 comprises a duct 25, here closed by the flap 2 in contact with the flange 11. This is to be understood as meaning that the fluid passing through the valve circulates in the duct 25 between an inlet and a first outlet of the valve, which are not shown. In contrast, when the flap is in the open position, the fluid circulates in the valve from the inlet toward a second outlet, also not shown, or at the same time toward the first and second outlets.

At one of its ends, the shaft 7 protrudes, through a passage 26 created in the casing 10, toward the transmission means. It is possible for said valve to comprise a first bearing 21, allowing the shaft to rotate, in said passage 26. At its other end, the shaft 7 is also mounted in the casing 10, in particular via the intermediary of a second bearing 21. Various axial end stops may also be provided in order to position said shaft in line with the axis of rotation.

In order to prevent the exhaust gases from circulating along the shaft 7 toward said transmission means, a seal 24 is arranged in the passage 26, about the shaft 7.

When the exhaust gases come into contact with the flap 2, the flap conducts the heat of these gases through the wings 3, 4, the barrel 5 and the shaft 7 toward the transmission means.

In the valve shown in FIG. 3, the heat of the exhaust gases is transmitted by the barrel 5 to the shaft 7 via the region of thermal conduction existing between the barrel and the shaft as far as the vicinity of the passage 26, with no possibility of upstream dissipation, causing high temperatures to arise in that portion of the shaft 7 passing through said passage 26.

According to the invention, in order to reduce the conduction of heat between the flap 2 and the shaft 7, the valve 1 comprises a cavity configured so as to position the region of thermal conduction axially set back from a first edge of the flap 2 oriented toward one axial end of the shaft 7 which is connected to the transmission means and/or to the motor for actuating the valve, that is to say, in this case, the edge of the flap facing toward the passage 26 and/or the seal 24. The temperature at a given point along the shaft 7, in this direction, is thus reduced.

According to the embodiment illustrated in FIG. 4, the cavity takes the form of an annular space 28 created by machining a portion of the outer wall of a portion 30 of length L of the shaft 7 such that the diameter of the shaft at the portion 30 is less than the diameter of the shaft at a portion 32 of the shaft, called a mounting portion, the mounting portion 32 being substantially of the same diameter as the bore 6 created in the barrel 5 in order to allow the shaft 7 to be secured in the bore 6 of the barrel 5.

In an alternative embodiment illustrated in FIG. 5, the first of the connecting barrels 5, located close to the first edge of the flap, that is to say that edge located to the right in the figure, is axially set back from said first edge.

The cavity, here labeled 34, is accordingly created in the barrel 5 and breaks the thermal bridge along the shaft 7 toward the end of the shaft oriented toward the seal 24.

In order to improve the dissipation of heat, a cavity 36, taking the shape of an annular space, is moreover created substantially in a median portion of the flap 2 between the first connecting barrel and a second one of the connecting barrels 5, located on the left in the figure.

As a variant, the barrel 5 is continuous along the shaft, while having its end which is oriented toward the recess 26 axially set back from said first edge of the flap.

In another embodiment of the invention, illustrated in FIG. 6 and combining the two embodiments described previously, a cavity, in this case labeled 42, is created both by machining the shaft 7 and by means of an axial offset of that barrel 5 which is closest to the passage 26.

FIG. 7 shows a variation in the shape of the flap 2.

Such a flap comprises a first wing 3 and a second wing 4 secured to a barrel 5 said wings being mounted symmetrically on either side of said barrel 5, that is to say in one and the same plane further comprising the axis of the barrel or the axis of rotation of the flap.

The wings 3 and 4 are in this case two portions of a circle configured such that the contour of the flap is substantially in the shape of a circle. The wings 3 and 4 and the barrel 5 may, for example, be formed directly from the same material.

The barrel 5 is substantially cylindrical and comprises a bore, also substantially cylindrical, created coaxially in the barrel 5.

FIG. 8 shows a valve 1 which takes the form of a casing 10 in which the flap 2 is mounted. In this case it is a dosing valve by means of which it is possible to close, to a greater or lesser degree, the duct 25 along which the flap 2 is mounted. As in the preceding valve, the shaft 7 comprises an end 22 mounted connected to the actuation motor 20, either directly or via the intermediary of transmission means. A passage 26 allows the shaft to pass from the duct 25 toward the motor and/or the transmission means. It is fitted with a bearing 21.

Sealing means 18, in this case in the form of a lip seal, make it possible to prevent the exhaust gases, circulating in the clearances provided between the flap 2, the casing 10 and the shaft 7, from entering a recess created in the casing 10 in order to reach the actuating motor 20 and/or the transmission means via the passage 26.

That said, when the exhaust gases come into contact with the flap 2, the flap conducts the heat of these gases through the wings 3, 4, the barrel 5 and the shaft 7 toward the actuating motor. The problem is thus the same as in the valve of FIG. 3.

FIG. 10 illustrates a solution according to the invention and similar to that of FIG. 5. In this case, the cavity takes the form of an annular space 28 created by machining a portion of the outer wall of a portion 30 of length L of the shaft 7 such that the diameter of the shaft at the portion 30 is less than the diameter of the shaft at the portion 32 for mounting the shaft, the mounting portion 32 being substantially of the same diameter as the bore 6 created in the barrel 5 in order to allow the shaft 7 to be secured in the bore 6 of the barrel 5.

It can furthermore be seen that, as in the embodiment of FIG. 4, the diameter of the shaft is identical on either side of the portion 30 having the annular space 28.

In an alternative embodiment illustrated in FIG. 11, the cavity is created in the barrel 5. The cavity is configured so as to form a heat shield along the shaft 7 in the direction of that end of the shaft located on the side of the passage 26.

The cavity takes the form here of an annular space 36 created by machining a portion of the barrel 5.

In another embodiment of the invention, illustrated in FIG. 12 and combining the two embodiments described previously, a cavity 36 is created by machining both in the barrel 5 and in the shaft 7.

In these various embodiments, it can be seen that the cavity extends on one hand axially from a region of the shaft which enters the passage 26, toward a central portion of the duct 25, and on the other hand radially between the flap 2 and the shaft 7.

1. A gas valve for recirculated exhaust gases for a motor vehicle engine, comprising:
a flap;
a shaft for driving the flap about an axis of rotation, said flap and said shaft being push-fitted into one another at one or more connecting barrels establishing a region of thermal conduction between the flap and the shaft; and
at least one cavity located radially between the shaft and the flap and configured to locate the region of thermal conduction axially set back from a first edge of the flap facing toward one axial end of the shaft, which wherein the one axial end is connected to members for driving the valve.

2. The valve as claimed in claim 1, wherein the flap has a radial offset with respect to the axis of rotation and the connecting barrel or one of the connecting barrels which is close to the first edge of the flap is axially set back from said first edge, the space freed up by this axial setback forming the cavity.

3. The valve as claimed in claim 2, further comprising a second connecting barrel at a distance from the barrel provided close to the first edge.

4. The valve as claimed in claim 1, wherein the flap is aligned on the axis of rotation and the cavity is delimited by an annular space created in the barrel or the one of the barrels which is close to the first edge.

5. The valve as claimed in claim 4, wherein the thickness of the flap is less than the diameter of the connecting barrel.

6. The valve as claimed in claim 2, wherein the drive shaft is of constant cross section.

7. The valve as claimed in claim 1, wherein the cavity extends axially from a passage by means of which the shaft enters a body of the valve.

8. The valve as claimed in claim 7, wherein the cavity is delimited by an annular space created in a sidewall of the shaft.

9. The valve as claimed in claim 8, wherein the diameter of the shaft is smaller in its portion located at the annular space.

10. The valve as claimed in claim 9, wherein the diameter of the shaft is identical on either side of said annular space.

11. The valve as claimed in claim 7, wherein the flap is aligned on the axis of rotation.

12. The valve as claimed in claim 1, wherein the flap is aligned on the axis of rotation and the cavity is delimited by an annular space created in the barrel or the one of the barrels which is close to the first edge.

13. The valve as claimed in claim 12, wherein the thickness of the flap is less than the diameter of the connecting barrel.

14. The valve as claimed in claim 1, wherein the cavity is created both in the barrel and in the shaft.

15. The valve as claimed in claim 1, wherein the barrel or barrels are formed directly from the material of the flap.
